(19) United States
(12) Patent Application Publication
(10) Pub. No.: US 2007/0160126 A1
(43) Pub. Date: Jul. 12, 2007

(54) System and method for improved scalability support in mpeg-2 systems

(75) Inventors: Jan Van Der Meer, Heeze (NL); Wilhelmus H.A. Bruls, Eindhoven (NL); Renatus J. Van Der Vleuten, Veldhoven (NL); Ihor Kirenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,167

(22) PCT Filed: Dec. 2, 2004
(86) PCT No.: PCT/IB04/52647

§ 371 Date: Jun. 2, 2006

Related U.S. Application Data
(60) Provisional application No. 60/566,462, filed on Apr. 29, 2004.
(60) Provisional application No. 60/526,499, filed on Dec. 3, 2003.

(51) Int. Cl. H04B 1/66

(52) U.S. Cl. 375/240

(57) ABSTRACT

A heterogeneous layered video decoding system and associated method is disclosed that provides for flexible and cost effective scalability through the use of generic decoders (e.g., MPEG-2/4/AVC) at each layer instead of decoders specifically designed for scalable systems. In one embodiment, additional signaling information (220) embodied as a parameter list is transmitted along with the transport stream (250). The parameter list independently defines for each layer (BS, ES), how the particular layer is to be decoded. In this manner, a trade-off between complexity and efficiency is achieved. For example, the base layer (BS) may employ a sophisticated base layer AVC codec, while one or more enhancement layers (ES) may use an MPEG-2 codec that is half as complex as a full AVC codec but only slightly less efficient.

The present invention relates generally to scalable video coding systems, and more particularly, to a flexible and cost effective heterogeneous layered video decoding technique that allows the video encoding/decoding format to be independently selected per layer.

In recent years, digital video storage has been introduced on various media, such as hard disks and optical discs (e.g. DVD+RW). From a consumer point of view, the amount of recording time should be fixed or at least guaranteed. With current compression schemes this is achieved by controlling the quantize parameter. One drawback, however, is that the bit rate required for an artifact free picture greatly depends on the input sequence. For example, if the selected (average) bit rate is too low for an input sequence, it will result in coding artifacts like blocking as can be demonstrated using an appropriate metric. These artifacts could have been avoided if the sequence was compressed at a lower resolution. Although this is possible with current standards like MPEG, it is limited to only static sequences and in abrupt discrete steps (SDTV, 1/2D1, CIF). Such abrupt changes in resolution can be quite annoying for the viewer.

Apart from storage applications, the problem of occurring artifacts can also be observed in wireless video connections, e.g. using IEEE802.11b, were the available bit rate is not always sufficient to carry the full SDTV resolution.

What is needed, therefore, is a method which allows for dynamically adapted video resolution compression that can make use of existing compression standards like MPEG as building blocks.

The present invention addresses the foregoing need by providing a heterogeneous layered video decoding system and associated method that uses only generic MPEG-2/4/AVC decoders to decode an MPEG-2/4/AVC compliant stream. In one embodiment, this is achieved by utilizing a parameter list to be transmitted along with the MPEG-2/4/AVC compliant stream that independently defines for each layer, how the particular layer is to be decoded. The parameter list may define for each layer, values to determine: (1) whether the particular layer is be scaled up, down or not at all (2) whether DC compression is to be applied to the layer, (3) the type of stream (e.g., MPEG-2/4) that defines the layer, (4) the FIR coefficients, and (5) constant gains in the sub-band. The parameter values are preferably multiplexed along with the encoded signal to allow the decoder to interpret the parameter values and decode accordingly.

In one aspect, in the case where there are more than two enhancement layers, a wide range of quality levels may be defined. For each quality level, the encoder can transmit a separate parameter list. For example, for a four layer video stream including a base layer and three enhancement layers, a first parameter list could be constructed to define a combination of the base layer BS with both enhancement layers ES1 and ES2. A second parameter list could be constructed to define a combination of the base layer BS with the second and fourth enhancement layers (BS+ES2+ES4). Other combinations should be apparent to the reader. All of the combinations of interest to a user may be simultaneously transmitted as elements of parameter list.

The foregoing features of the present invention will become more readily apparent and may be understood by referring to the following detailed description of an illustrative embodiment of the present invention, taken in conjunction with the accompanying drawings, where:

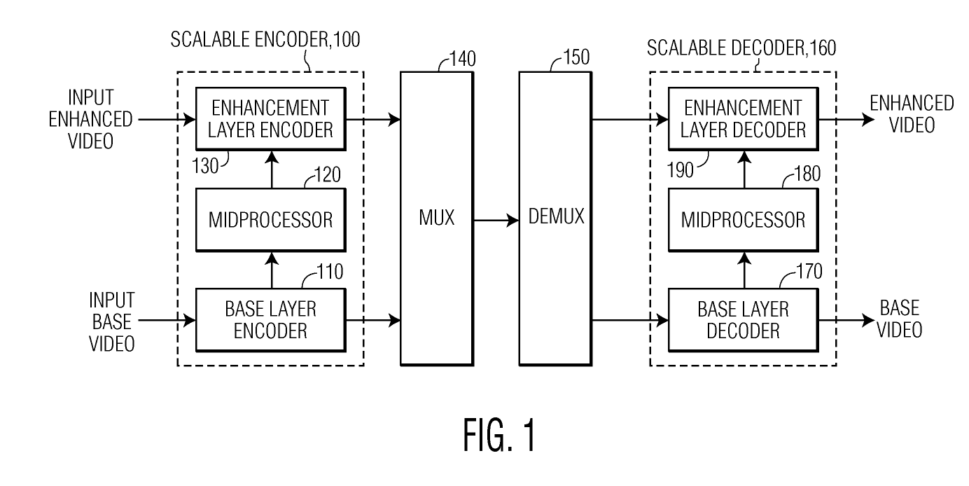

FIG. 1 is a block schematic representation for illustrating the principles of scalable coding (spatial scalability);

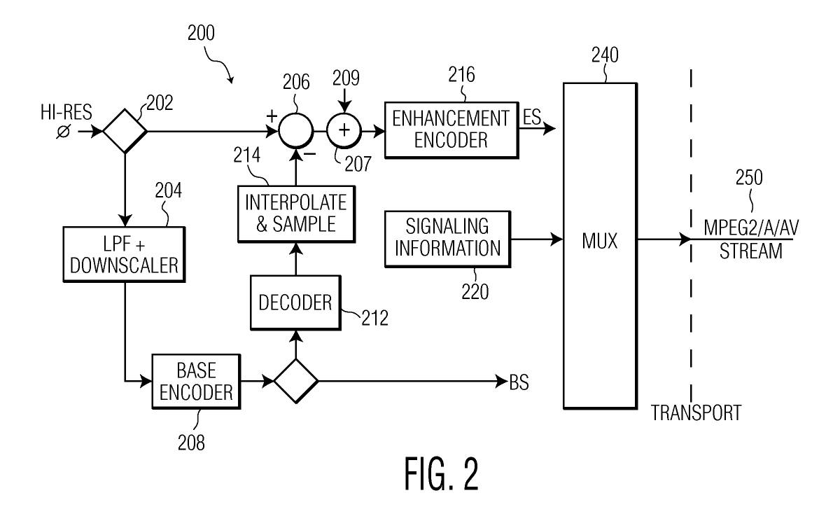

FIG. 2 is a block schematic representation of a spatial scalable video encoder according to one embodiment of the invention;

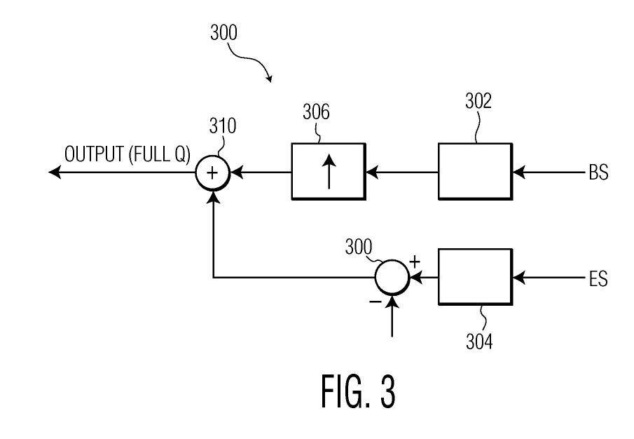

FIG. 3 is a block schematic representation of a spatial scalable video decoder for decoding the encoded signals processed by the layered encoder FIG. 2;

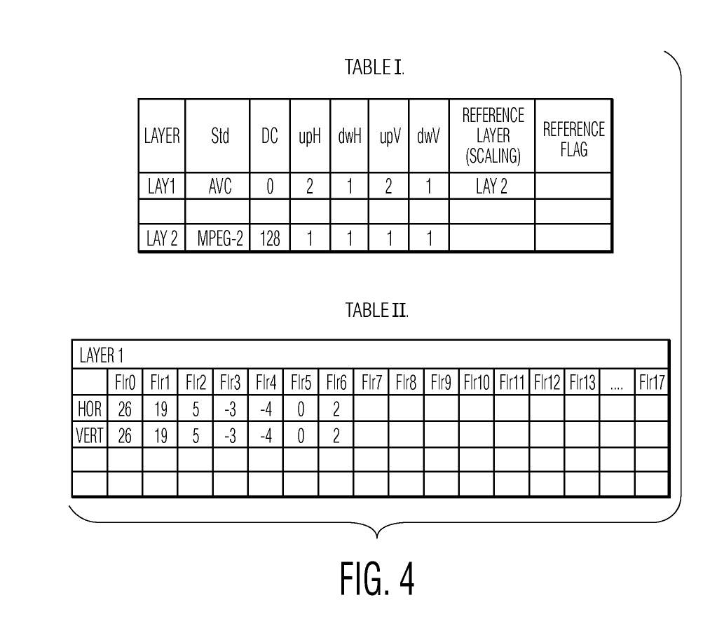

FIG. 4 illustrates one example of a parameter list that would be broadcast over a communication channel as supplemental information to inform a decoder as to how to combine the various streams (e.g., Lay1, Lay2) of a transport stream to output a single decoded video stream;

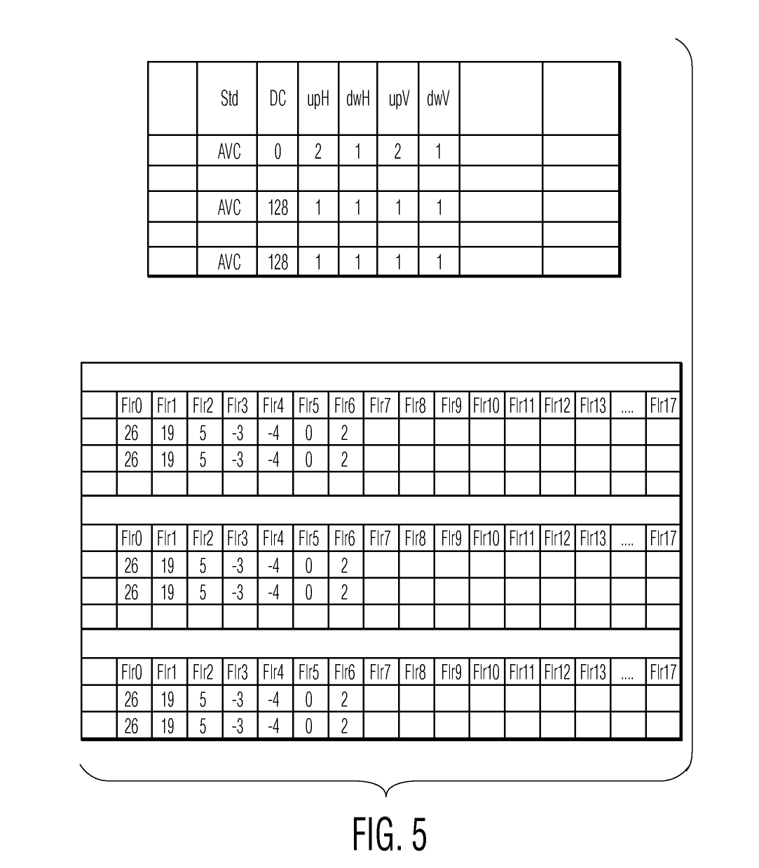

FIG. 5 illustrates another example of a parameter list that would be broadcast over a communication channel as supplemental information to inform a decoder as to how to combine the various streams (e.g., Lay1, Lay2) of a transport stream to output a single decoded video stream;

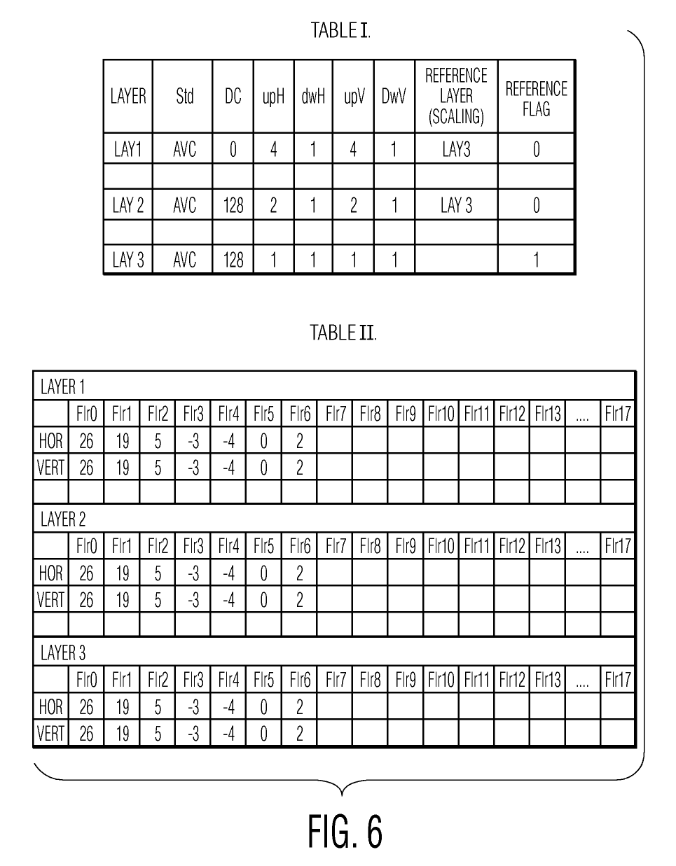

FIG. 6 illustrates a further example of a parameter list that would be broadcast over a communication channel as supplemental information to inform a decoder as to how to combine the various streams (e.g., Lay1, Lay2) of a transport stream to output a single decoded video stream;

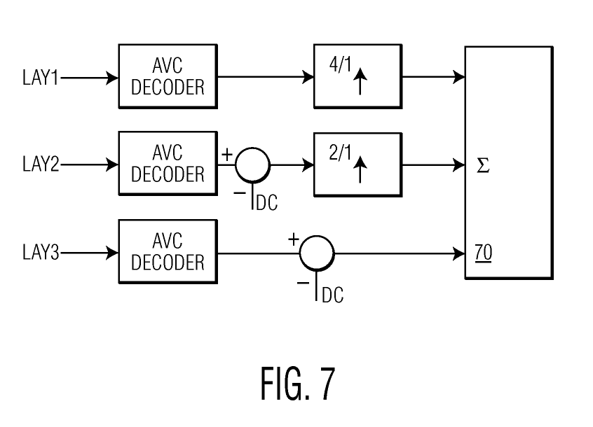

FIG. 7 is a block schematic representation of a spatial scalable video decoder for decoding the encoded signals in accordance with the parameter list of FIG. 6;

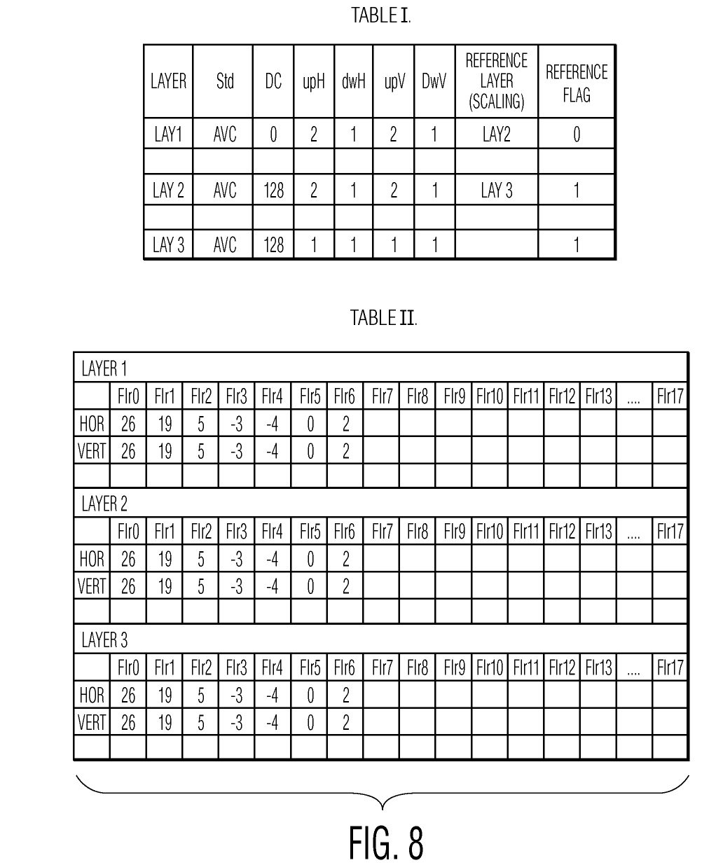

FIG. 8 illustrates a further example of a parameter list that would be broadcast over a communication channel as supplemental information to inform a decoder as to how to combine the various streams (e.g., Lay1, Lay2) of a transport stream to output a single decoded video stream; and

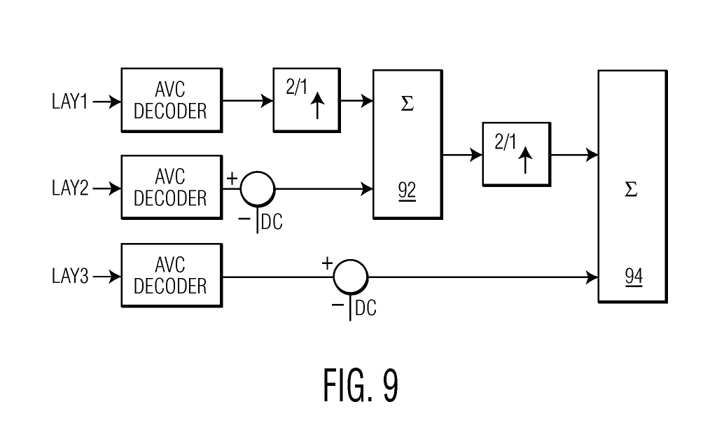

FIG. 9 is a block schematic representation of a spatial scalable video decoder for decoding the encoded signals in accordance with the parameter list of FIG. 8.

Although the following detailed description contains many specifics for the purpose of illustration, one of ordinary skill in the art will appreciate that many variations and alterations to the following description are within the scope of the invention. Accordingly, the following preferred embodiment of the invention is set forth without any loss of generality to, and without imposing limitations upon, the claimed invention.

The invention provides a number of specific advantages over prior art systems. Specifically, the system and method of the invention provides for flexible and cost effective scalability through the use of generic MPEG-2/4/AVC decoders at each layer instead of decoders specifically designed for scalable systems. A further advantage of the invention is that it allows for trade-offs between complexity and efficiency. For example, the base layer may employ a sophisticated base layer AVC codec, while one or more enhancement layers may use an MPEG-2 codec that is half as complex as a full AVC codec but only slightly less efficient. A still further advantage is that the system and method of the invention allows for seamless migration from one standard to another. In other words, presently the majority of broadcasters broadcast using the MPEG compression standard. As newer compression standards emerge, the same signal quality can be achieved at a lower bit rate. The present invention allows the base layer to be transmitted using the MPEG compression standard and as equipment upgrades are realized, the enhancement layers can be transmitted using the newer compression standards. The migration can occur gradually as the system of the invention can be adapted to any quality of service (QOS) configurations defined by the user.

A further advantage of providing heterogeneous layered video support is illustrated in the case where a user is initially only decoding a video stream in the base layer in a set top box, for example. Assume at some later point in time that the user also desires to use the Internet as an overlay. That is, in addition to supporting the video coding at the base layer, the decoding of the video stream at the base layer remains fully supported by simply utilizing a lower quality of service (Qos) at the enhancement layer(s). Another advantage is a cost savings which may be realized when using generic MPEG-2/4/AVC decoders as compared with full quality advanced (complex) codecs. A further advantage is low power (base layer only) decoding for battery operated, portable or mobile, equipment; quality of service (Qos) with respect to the transport of bits, and quality of service with respect to the cycle budget of a DSP.

A brief review of general scalable coding (spatial scalability) is first provided. Many applications desire the capability to transmit and receive video at a variety of resolutions and/or qualities. One method to achieve this is with scalable or layered coding, which is the process of encoding video into an independent base layer and one or more dependent enhancement layers. This allows some decoders to decode the base layer to receive basic video and other decoders to decode enhancement layers in addition to the base layer to achieve higher temporal resolution, spatial resolution, and/or video quality.

The general concept of scalability is illustrated in FIG. 1 for a codec with two layers. Note that additional layers can be used. The scalable encoder 100 takes two input sequences and generates two bit streams for multiplexing at a mux 140. Specifically, the input base video stream or layer is processed at a base layer encoder 110, and upsampled at a midprocessor 120 to provide a reference image for predictive coding of the input enhanced video stream or layer at an enhancement layer encoder 130.

Note that coding and decoding of the base layer operate exactly as in the non-scalable, single layer case. In addition to the input enhanced video, the enhancement layer encoder uses information about the base layer provided by the midprocessor to efficiently code the enhancement layer. After communication across a channel, which can be, e.g., a computer network such as the Internet, or a broadband communication channel such as a cable television network, the total bit stream is demultiplexed at a demux 150, and the scalable decoder 160 simply inverts the operations of the scalable encoder 100 using a base layer decoder 170, a processor 180, and an enhancement layer decoder 190.

The MPEG standard refers to the processing of hierarchical ordered bit stream layers in terms of “scalability”. One form of MPEG scalability, termed “spatial scalability” permits data in different layers to have different frame sizes, frame rates and chrominance coding. Another form of MPEG scalability, termed “temporal scalability” permits the data in different layers to have different frame rates, but requires identical frame size and chrominance coding. In addition, “temporal scalability” permits an enhancement layer to contain data formed by motion dependent predictions, whereas “spatial scalability” does not. These types of scalability, and a further type termed “SNR scalability”, (SNR is Signal to Noise Ratio) are further defined in section 3 of the MPEG standard.

FIG. 2 illustrates a spatial scalable video encoder 200 according to one embodiment of the invention. The depicted encoding system 200 accomplishes layer compression, whereby a portion of the channel is used for providing a low resolution base layer (BS) and the remaining portion is used for transmitting edge enhancement information (ES), whereby the two signals may be recombined to bring the system up to high-resolution. A high resolution (Hi-Res) video input signal is split by splitter 202 whereby the data is sent, in one direction, to a low pass filter (LPF) & downscaler 204 and, in another direction, to a subtraction circuit 206. The low pass filter & downscaler 204 reduces the resolution of the video data, which is then fed to a base encoder 208. In general, low pass filters and encoders are well known in the art and are not described in detail herein. The base encoder 208 produces a lower resolution base stream BS which is one input of multiplexer 240.

The output of the base encoder 208 is also fed to a decoder 212 within the system 200. From there, the decoded signal is fed into an interpolate and upsample circuit 214. In general, the interpolate and upsample circuit 214 reconstructs the filtered out resolution from the decoded video stream and provides a video data stream having the same resolution as the high-resolution input. However, because of the filtering and the losses resulting from the encoding and decoding, loss of information is present in the reconstructed stream. The loss is determined in the subtraction circuit 206 by subtracting the reconstructed high-resolution stream from the original, unmodified high-resolution stream. The output of the subtraction circuit 206 is fed into a modification unit 207. The modification unit 207 transforms the residual signal into a signal with the same signal level range as a normal input video signal as used for video compression. The modification unit 207 adds a DC-offset value 209 to the residual signal. The modification unit 207 also comprises a clip function which prevents the output of the modification unit from going below a predetermined value and above another predetermined value. This DC-offset and clipping operation allows the use of existing standards, e.g., MPEG, for the enhancement encoder where the pixel values are in a predetermined range, e.g., 0 . . . 255. The residual signal is normally concentrated around zero. By adding a DC-offset value 209, the concentration of samples can be shifted to the middle of the range, e.g., 128 for 8 bit video samples. It is noted that to allow for the use of generic MPEG-2/4/AVC decoders at each layer instead of decoders specifically designed for scalable systems, a DC-offset value is applied prior to encoding and subsequent to decoding.

With continued reference to FIG. 2, the transformed residual signal from the modification unit 207 is fed to an enhancement encoder 216 which outputs a reasonable quality enhancement stream ES which represents a further input of multiplexer 240.

A key feature of the invention is represented by a third input supplied to multiplexer 240. The third input comprises signaling information 220 embodied as a parameter list which is transmitted along with the MPEG-2/4/AVC compliant stream 250. The parameter list independently defines for each layer, how the particular layer is to be decoded.

In one embodiment, the parameter list 220 includes additional signaling information embodied as parameter values to instruct the decoder on how to properly combine the various layers (e.g., BS, ES) at the decoder into a single decoded bit stream.

The parameter values may define, for example:

(1) a horizontal and vertical scaling factor to be applied to each layer (e.g., scale-up, scale-down, no scaling)

(2) DC compression to be applied (if any) to each layer

(3) the stream type (e.g., MPEG-2, MPEG-4, AVC, etc.),

(4) the FIR coefficients associated with the scaling, (the more complex you make the FIR filter, the more perfect the scaling. It is noted that better results are achieved if the decoder knows which coefficients were used in the encoder and

(5) constant gains in the sub-band.

(6) an identifier for a reference layer to be combined with a current layer;

(7) how a current layer is to be combined with a reference layer;

(8) whether a corresponding layer contains one of an interlaced or progressive video stream.

As shown, the parameter list 220 (i.e., signaling information) is multiplexed along with the encoded signal for each layer (BS, ES) to allow the decoder to interpret the parameter values and decode the MPEG 2/4/AVC stream 250 accordingly.

It should be appreciated that while the encoder 200 of FIG. 2 illustrates a two-layer system, the invention has broader applicability to higher order (additional) enhancement layers.

It is noted that, to achieve the objective of a simple and straightforward concept for layering, a number of constraints are applied:
each layer has the same temporal resolution;
each layer codes the same picture area, but the resolution in each layer may differ,

It is further noted that in accordance with the method of the invention for providing heterogeneous layered video support, the at least two layers (BS, ES) may be transmitted, in one embodiment, over Internet Protocol using real-time transport protocol (RTP) in a transmission session for each layer. While, the signaling information (220) is transmitted within the context of the transmission session either in-band or out-of-band within the transmission session. The signaling information could, for example, be transmitted using session description protocol (SDP).

In accordance with another embodiment, the at least two layers (BS, ES) may be transmitted over at least one of an MPEG-2 transport stream, an MPEG-2 program stream and an Internet Protocol (IP) stream to the decoder, and the signaling information could similarly be transmitted over at least one of an MPEG-2 transport stream, an MPEG-2 program stream and an Internet Protocol (IP) stream to the decoder.

In order to implement the functionality described herein, it is proposed that an amendment to the MPEG-2 standard is required. The following describes the details of the proposed amendment. The details of the proposed amendment are disclosed as: (I) amendments to the stream type assignments of the MPEG-2 standard, and (II) amendments to the program and program element descriptors of the MPEG-2 standard.

I Added: the Differential Video Stream Descriptor

The differential video stream descriptor specifies the coding format of the associated stream as well as the applied DC offset. For each differentially coded video stream carried in an ITU-T Rec. H.222.0 ISO/IEC 13818-1 stream (i.e., the document number of the MPEG-2 system standard), the differential video stream descriptor shall be included in the PMT (Program Map Table) or in the PSM (Program Stream Map), if PSM is present in the program stream.

TABLE I
Fields of differential video stream descriptor

| Syntax | | No. of bits | Mnemonic |
|---|---|---|---|
| Differential video stream descriptor( ) { | | | |
| | descriptor_tag | 8 | uimsbf |
| | descriptor_length | 8 | uimsbf |
| | stream_type | 8 | uimsbf |
| | DC_offset | 16 | uimsbf |

}

Semantic definition of fields of Table I:
(a) stream type—An 8 bit unsigned integer that specifies the encoded format of the associated differential video stream, encoded as specified in table 2-29 of ITU-T Rec. H.222.0 ISO/IEC 13818-1. Stream_type values that indicate other than video streams are forbidden. Also a stream type value of 0×1C is forbidden.
(b) DC offset—A 16 bit unsigned integer that specifies the DC offset that shall be applied on the decoded signal when reconstructing the video output,
   II. Added: The Spatially Layered Video Stream Descriptor

The spatially layered video stream descriptor specifies for a video stream in a layered video system, the layer, the exact horizontal and vertical re-sampling factors, and the recommended filter coefficients for the horizontal and vertical re-sampling, as specified in 2-15. The spatially layered video stream descriptor shall be associated to each video stream, hence to each base and each enhancement stream, in a layered video system. For each such stream carried in an ITU-T Rec. H.222.01 |ISO/IEC 13818-1 stream, the spatially layered video stream descriptor shall be included in the PMT or in the PSM, if PSM is present in the program stream.

TABLE II
Fields of spatially layered video stream descriptor

| Syntax | | No. of bits | Mnemonic |
|---|---|---|---|
| Spatially layered video stream descriptor( ) { | | | |
| | descriptor_tag | 8 | uimsbf |
| | descriptor_length | 8 | uimsbf |
| | layer | 4 | uimsbf |
| | reference_layer | 4 | uimsbf |
| | referenced_flag | 1 | bslbf |
| | reserved | 7 | bslbf |
| | if(referenced_flag=‘0’) ∥ ((referenced_flag=‘1’) && | | |

(reference_layer>0)){

| | | |
|---|---|---|
| up_horizontal | 4 | uimsbf |
| down_horizontal | 4 | uimsbf |
| up_vertical | 4 | uimsbf |
| down_vertical | 4 | uimsbf |
| number_of_horizontal_coefficients | 4 | uimsbf |
| number_of_vertical_coefficients | 4 | uimsbf |
| for (i=0; | | |

| | | |
|---|---|---|
| i<number_of_horizontal_coefficients;i++){ | 16 | uimsbf |

hor_fir(i)

}
for (i=0; i<number_of_vertical_coefficients;i++){

| | | |
|---|---|---|
| ver_fir(i) | 16 | uimsbf |

}

}

}

Semantic definition of fields of Table II:
(a) layer—A 4 bit unsigned integer that specifies the index number of the layer of the associated video stream.
(b) reference_layer—A 4 bit unsigned integer that identifies the index number of the layer of the video stream with the spatial resolution to which this video stream is re-sampled. For example, a reference layer value of 0 indicates that this video stream is not re-sampled.
(c) referenced_flag—A one bit flag that, if set to ‘1’, indicates that this video stream has a spatial resolution to which one or more other streams are re-sampled.

If the referenced_flag is set to ‘0’, then this descriptor contains filter information for the re-sampling to the resolution of video stream referenced by the reference_layer field.

If the referenced_flag is set to ‘0’, then the preceding referenced_layer field shall be coded with a value larger than zero.

If the referenced_flag is set to ‘1’, while the preceding reference_layer field is coded with a value larger than zero, then this descriptor contains filter information for the next stage re-sampling of the intermediate re-sample result at the spatial resolution of this stream to the resolution of video stream referenced by the reference_layer field.
(d) up_horizontal, down_horizontal—Two 4 bit unsigned integers specifying that the horizontal re-sampling factor shall be equal to (up_horizontal)/(down_horizontal). A re-sampling factor larger than 1 (for example 8/3) indicates up-sampling, a factor smaller than 1 down-sampling. For both fields a value of zero is forbidden.
(e) up_vertical, down_vertical—Two 4 bit unsigned integers that specify that the vertical re-sampling factor shall be equal to (up_vertical)/(down_vertical). A re-sampling factor larger than 1 (for example 8/3) indicates up-sampling, a factor smaller than 1 down-sampling. For both fields a value of zero is forbidden.
(f) number_of_horizontal_coefficients—A 4 bit unsigned integer that specifies the number of horizontal filter coefficients in this descriptor.
(g) number_of_vertical_coefficients—A 4 bit unsigned integer that specifies the number of vertical filter coefficients in this descriptor.
(h) hor_fir(i)—A 16 bit unsigned integer that specifies the horizontal FIR filter coefficient with index i. The central coefficient has index value zero.

By defining the above signaling parameters per layer, a high degree of flexibility is achieved. Particularly, in the prior art it is a requirement that the base layer exist at the lowest resolution. In the present scheme, no such limitation exists. The aforementioned parameters may be independently defined for each layer, independent of any other layer.

Another feature of the invention is the case where multiple enhancement layers are defined. In this case, a separate parameter list could be constructed to define a multiplicity of quality levels. For example, for a four layer video stream including a base layer and three enhancement layers, a first parameter list could be constructed to define a combination of the base layer BS with both enhancement layers ES1 and ES2. A second parameter list could be constructed to define a combination of the base layer BS with the second and fourth enhancement layers (BS+ES2+ES4). Other combinations should be apparent to the reader. All of the combinations of interest to a user may be simultaneously transmitted as elements of parameter list 220.

FIG. 3 illustrates a decoder 300 according to one embodiment of the invention. FIG. 3 illustrates a decoder for decoding the encoded signals processed by the layered encoder 200 of FIG. 2. The base stream BS is decoded in base decoder 302 in accordance with those parameters from parameter list 200 which are associated with the base layer BS. The decoded output from the decoder 302 is upconverted by an upconverter 306 and then supplied to an addition unit 310. The enhancement stream ES is decoded in a decoder 304 in accordance with those parameters from parameter list 200 which are associated with the enhancement stream ES. The modification unit 308 performs the inverse operation of the modification unit 207 in the encoder 200. The modification unit 308 converts the decoded enhancement stream from a normal video signal range to the signal range of the original residual signal. The output of the modification unit 208 is supplied to the addition unit 310, where it is combined with the output of the upconverter 306 to form the output of the decoder 300.

### EXAMPLES

### Example 1

### A Dual Layer Configuration Utilizing an AVC Decoder in the Base Layer and an MPEG-2 Decoder in the Enhancement Layer

Referring to FIG. 4, Tables I and II define a parameter list 220 that would be broadcast over a communication channel as supplemental information to inform a decoder as to how to combine the various streams (e.g., Lay1, Lay2) to output a single decoded video stream.

Referring to the first row of the parameter list, (i.e., the row describing parameters specific to the base layer, Lay 1) the encoder side parameter list instructs the decoder to use an AVC decoder in the base layer (Lay1). Next, the parameter list instructs the decoder that the DC offset parameter is zero. This instructs the decoder 300 not to subtract a DC offset in the base layer prior to combining this layer with the enhancement layer, Lay2. The next four columns of the first row are labeled upH, dwH, upV and dwV, respectively, and refer to an upscaling factor in the horizontal (upH), downscaling factor in the horizontal (dwH), an upscaling factor in the vertical (upV) and a downscaling factor in the vertical (dwV). The decoder 300 uses these parameter in pairs. That is, the decoder 300 takes a ratio of the first two parameters, upH/dwH to determine whether the horizontal is to be upscaled, downscaled or not scaled at all. In the present example, the horizontal scaling ratio
Hor. Scaling ratio=upH/dwH=2/1=2 (1)
Similarly, for the vertical direction, the decoder 300 takes a ratio of upV/dwV to determine whether the vertical is to be upscaled, downscaled or not scaled at all. In the present example, the vertical scaling ratio
Ver. Scaling ratio=upV/dwV=2/1=2 (2)
After performing any DC offsets and adjusting for the appropriate horizontal and vertical offsets, the next column refers to what layer the previous layer is to be added to. After performing the operations described on the base layer (Lay1) the result is combined with the single enhancement layer, Lay2.

Table I provides a number of parameters specific to the enhancement layer, Lay2. Specifically, the parameter list instructs the decoder to use an MPEG-2 decoder for the single enhancement layer, Lay2. The parameter list further instructs the decoder to perform a DC offset of 128. The (recommended) filter coefficients for performing this offset are defined in Table II. Specifically, seven filter coefficients are defined in both the horizontal and vertical direction.

### Example 2

### Three Layer Configuration Utilizing an AVC Decoder in the Base Layer (Lay 1) and Both Enhancement Layers (Lay2, Lay3)

Referring now to FIG. 5, Tables I and II define a parameter list 220 that would be broadcast over a communication channel as supplemental information to inform a decoder as to how to combine the various streams to output a single decoded video stream.

Referring to the first row of Table I of the parameter list, the parameter list instructs the decoder to use an AVC decoder in the base layer (Lay1). The parameter list further instructs the decoder that the DC offset parameter is zero. This instructs the decoder 300 not to subtract a DC offset in the base layer prior to combining this layer with the first enhancement layer, Lay2. In the present example, the horizontal scaling ratio is 2 and the vertical scaling ratio is also 2. The next column refers to what layer the base layer, Lay1, is to be added to. In this case, Lay1 is to be added to Lay2, the first enhancement layer. Both enhancement layers, i.e., Lay2 and Lay3 have similar parameter values defining DC offsets of 128 and no scaling in both the horizontal and vertical directions.

### Example 3

### Three Layer Configuration Utilizing an AVC Decoder in the Base Layer and Both Enhancement Layers. Each Layer Added in a Parallel Configuration

Referring to FIGS. 6 and 7, Tables I and II of FIG. 6 define a parameter list 220 that would be broadcast over a communication channel as supplemental information to inform a decoder as to how to combine the various streams (i.e., Lay1, Lay2, Lay3) to output a single decoded video stream.

Referring to the first row of Table I of the parameter list of FIG. 6, the parameter list instructs the decoder to use an AVC decoder in the base layer (Lay1). The parameter list further instructs the decoder that the DC offset parameter is zero. This instructs the decoder 300 not to subtract a DC offset in the base layer prior to combining this layer with the first enhancement layer, Lay2. In the present example, the horizontal scaling ratio is calculated as 2 and the vertical scaling ratio is calculated as 2. The next column “Reference Layer (scaling)” refers to which layer the base layer, Lay1, is to be added to next. In this case, Lay1 is to be added to Lay2, the first enhancement layer. The next column, “Reference flag” defines a parameter value for instructing the decoder on the order in which any required DC compensation and scaling is to be performed for the present layer (Lay1) prior to summing it with the layer defined by the Reference flag parameter. In the instant example, Lay 1 requires no DC compensation, however a “Reference Flag” parameter value of one (1) instructs the decoder to perform any required scaling, which in the instant case is 4/1, prior to summing Lay1 with Lay2, via summation block 72 of FIG. 7.

Continuing with the instant example, referring now to Lay2, the first enhancement layer, the “Reference Flag” parameter value of zero (0) as before, instructs the decoder to apply any required DC compensation and scaling to Lay2 prior to summing Lay2 with Lay3.

### Example 4

### Three Layer Configuration Utilizing an AVC Decoder in the Base Layer and Both Enhancement Layers

Referring to FIGS. 8 and 9, Tables I and II of FIG. 8 define a parameter list 220 that would be broadcast over a communication channel as supplemental information to inform a decoder as to how to combine the various streams (i.e., Lay1, Lay2, Lay3) to output a single decoded video stream.

Referring to the first row of Table I of the parameter list, the encoder side parameter list instructs the decoder to use an AVC decoder in the base layer (Lay1). The parameter list further instructs the decoder that the DC offset parameter is zero. This instructs the decoder 300 not to subtract a DC offset in the base layer prior to combining this layer with the first enhancement layer, Lay2. In the present example, the horizontal scaling ratio is calculated as 2 and the vertical scaling ratio is calculated as 2. The next column “Reference Layer (scaling)” refers to which layer the base layer, Lay1, is to be added to next. In this case, Lay1 is to be added to Lay2, the first enhancement layer. The next column, “Reference flag” defines a parameter value for instructing the decoder to perform any required DC compensation and scaling for the present layer (Lay1) prior to summing it with the layer defined by the Reference flag parameter. In the instant example, Lay1 requires no DC compensation, however and a 4/1 scaling prior to summing it with Lay2, the first enhancement layer.

Continuing with the instant example, referring now to Lay2, the “Reference Flag” parameter value of one (1) instructs the decoder to apply any required DC compensation to the present layer as before. However, in this case, the value of one (1) instructs the decoder to apply scaling after the present layer is summed with the previous layer. In the instant example, a DC compensation of 128 is performed for Lay2, followed by a summation with Lay 1, via summation block 92 of FIG. 9, followed by a 2/1 scaling of the output of the output of summation block 92 of FIG. 9.

Continuing with the instant example, referring now to Lay3, the second enhancement layer, the “Reference Flag” parameter value of one (1) once again instructs the decoder to apply any required DC compensation to the present layer as before, which for the present layer is a DC compensation of magnitude 128, identical to that applied to the previous layer. Because the scaling factor for the present layer if one (1), there is no scaling block shown to the right of summation block 94 of FIG. 9.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

1. A method for providing heterogeneous layered video support, comprising the acts of:
constructing signaling information (220) defining how at least two layers (BS, ES) are to be combined at a decoder (200); and
transmitting the signaling information along with the at least two layers (BS, ES) in a transport stream (250) to the decoder (200).

2. The method of claim 1, wherein said transport stream (250) is an MPEG-2 transport stream.

3. The method of claim 1, wherein said signaling information (220) is constructed as a plurality of parameter lists.

4. The method of claim 3 where each of said plurality of parameter lists define a unique quality of service (QOS) of said transport stream (250).

5. The method of claim 1, wherein said signaling information (220) is constructed as a parameter list.

6. The method of claim 5, wherein said parameter list is comprised of a plurality of parameter values.

7. The method of claim 6, wherein said parameter values define signaling information for each of said at least two layers (BS, ES).

8. The method of claim 6, wherein one of said parameter values defines, for a corresponding layer, a DC compensation.

9. The method of claim 8, wherein at least two of said parameter values define, for a corresponding layer, horizontal FIR coefficients for to a filtering operation required to combine the corresponding layer with a reference layer.

10. The method of claim 8, wherein at least two of said parameter values define, for a corresponding layer, vertical FIR coefficients for a filtering operation required to combine the corresponding layer with a reference layer.

11. The method of claim 6, wherein one of said parameter values defines, for a corresponding layer, a video stream encoding type.

12. The method of claim 6, wherein a ratio of two of said parameter values defines, for a corresponding layer, a horizontal scaling factor.

13. The method of claim 6, wherein a ratio of two of said parameter values defines, for a corresponding layer, a vertical scaling factor.

14. The method of claim 6, wherein one of said parameters defines an identifier of the reference layer to be combined with a current layer.

15. The method of claim 6, wherein one of said parameters determines how the current layer is combined with the reference layer.

16. The method of claim 15, wherein the current layer is combined with the reference layer in one of a parallel and sequential manner.

17. The method of claim 6, wherein one of said parameters defines whether a corresponding layer contains one of an interlaced or progressive video stream.

18. The method of claim 1, wherein the signaling information is embedded by means of MPEG system descriptors.

19. A method for providing heterogeneous layered video support, comprising the acts of:
constructing signaling information (220) defining how at least two layers (BS, ES) are to be combined at a decoder (200); and
transmitting the signaling information (220) along with the at least two layers (BS, ES) in a program stream to the decoder (200).

20. The method of claim 19, wherein said program stream is an MPEG-2 program stream.

21. A method for providing heterogeneous layered video support, comprising the acts of:
constructing signaling information (220) defining how at least two layers (BS, ES) are to be combined at a decoder (200); and
transmitting the at least two layers (BS, ES) over at least one of an MPEG-2 transport stream, an MPEG-2 program stream and an Internet Protocol (IP) stream to the decoder; and
transmitting the signaling information over at least one of an MPEG-2 transport stream, an MPEG-2 program stream and an Internet Protocol (IP) stream to the decoder (200).

22. A method for providing heterogeneous layered video support, comprising the acts of:
constructing signaling information (220) defining how at least two layers (BS, ES) are to be combined at a decoder (200);
transmitting the at least two layers (BS, ES) over Internet Protocol using real-time transport protocol (RTP) in a transmission session for each layer; and
transmitting the signaling information (220) within the context of said transmission session.

23. The method of claim 22, wherein said signaling information (220) is transmitted in-band within said session.

24. The method of claim 22, wherein said signaling information (220) is transmitted out-of-band within said session.

25. The method of claim 22, wherein said signaling information (220) is transmitted using session description protocol (SDP).
